(19) United States
(12) Patent Application Publication
(10) Pub. No.: US 2025/0200008 A1
(43) Pub. Date: Jun. 19, 2025

(54) EVENT-DRIVEN ERP INTEGRATION FRAMEWORK FOR REAL-TIME DATA SYNCHRONIZATION

(71) Applicants: Hanumantha Rao Kavuri, Herriman, UT (US); Srujan Reddy Anugu, Mason, OH (US); Durga Rao Manchikanti, South Jordan, UT (US); Nishanth Vepachedu, Holladay, UT (US)

(72) Inventors: Hanumantha Rao Kavuri, Herriman, UT (US); Srujan Reddy Anugu, Mason, OH (US); Durga Rao Manchikanti, South Jordan, UT (US); Nishanth Vepachedu, Holladay, UT (US)

(21) Appl. No.: 19/064,765

(22) Filed: Feb. 27, 2025

(51) Int. Cl. G06F 16/178; G06F 9/54; G06Q 10/087

(52) U.S. Cl. CPC G06F 16/178; G06F 9/542; G06Q 10/087

(57) ABSTRACT

The present invention relates to event-driven ERP integration framework for real-time data synchronization. The Event-Driven ERP Integration Framework revolutionizes enterprise system integrations by shifting from batch-based processing to a real-time event-driven model. This approach ensures instant data synchronization, enhanced scalability, and improved fault tolerance, significantly reducing operational overhead and inefficiencies. By leveraging message-driven architectures and AI-enhanced anomaly detection, the framework empowers enterprises with agile, responsive, and intelligent ERP integrations, positioning them for sustained operational excellence in dynamic business environments.

### TECHNICAL FIELD

This invention relates to enterprise resource planning (ERP) systems, specifically to real-time integration frameworks that enable seamless communication between ERP systems and third-party applications such as e-commerce platforms, payment gateways, and warehouse management systems (WMS).

### BACKGROUND OF THE INVENTION

Modern ERP systems face significant challenges in integrating with third-party applications. Traditional integration methods rely heavily on batch processing, leading to delays in data synchronization, order processing, and decision-making. These inefficiencies result in data latency, scalability issues, and increased operational overhead, ultimately degrading customer experience.

Traditional batch-based ERP integration models have numerous limitations. Existing message queuing architectures, but without direct ERP integration for real-time event handling. Predictive analytics solutions are applied to ERP integrations in non-real-time environments.

Thus, there is a need for event-driven ERP integration framework for real-time data synchronization.

### BRIEF SUMMARY OF THE INVENTION

The present invention introduces an Event-Driven ERP Integration Framework that leverages real-time event streaming architectures, including Apache Kafka, AMQP, and SAP Event Mesh. This framework enables instantaneous data exchange between ERP systems and external applications, eliminating batch dependencies, enhancing scalability, and providing a highly responsive and fault-tolerant integration ecosystem.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 illustrates flow chart for event-driven ERP integration framework for real-time data synchronization according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to one embodiment of the invention, the Event-Driven ERP Integration Framework introduces a real-time event-driven architecture (EDA) that facilitates asynchronous communication between ERP and third-party systems.

According to one embodiment of the invention, a system for real-time integration between ERP systems and third-party applications is disclosed. The system comprises an event bus utilizing message brokers such as Apache Kafka, AMQP, or SAP Event Mesh, a real-time data synchronization module that streams events as they occur, an asynchronous processing architecture that decouples ERP processes from third-party applications, an intelligent event handling module with filtering, transformation, routing, and AI-driven anomaly detection.

According to one embodiment of the invention, the following are the key features of the invention
i) Event Bus and Message Brokers:

Employs Apache Kafka, AMQP, or SAP Event Mesh for event-driven messaging.

Enables high-throughput, low-latency communication without direct API calls.
ii) Real-Time Data Synchronization:

Streams events in real time, ensuring immediate synchronization across systems.

Enhances accuracy in order processing, inventory management, and payment reconciliation.
ii) Asynchronous Processing and Scalability:

Decouples ERP core processes from third-party applications.

Dynamically scales event consumers to handle fluctuating transaction volumes.
iii) Intelligent Event Handling:

Applies filtering, transformation, and routing rules to incoming events.

Utilizes AI algorithms for anomaly detection, enabling proactive error resolution.

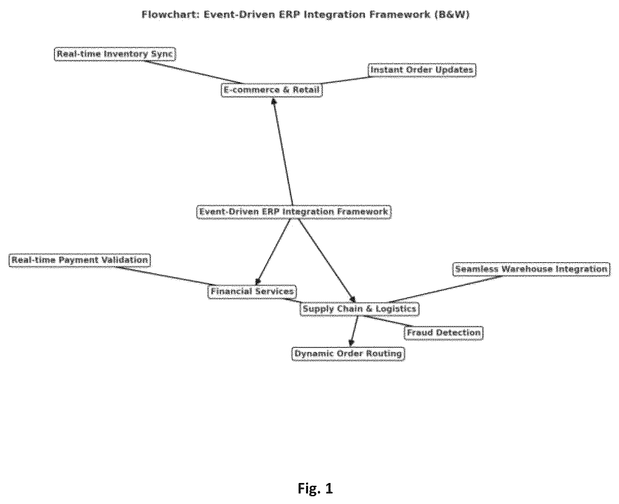

FIG. 1 illustrates flow chart for event-driven ERP integration framework for real-time data synchronization according to one embodiment of the invention. As shown in FIG. 1, the event-driven ERP integration framework comprises
i) Event Bus and Message Brokers:

Utilizes Apache Kafka, AMQP, or SAP Event Mesh for event-driven messaging.

Ensures low-latency, high-throughput communication.
ii) Real-Time Data Synchronization:

Streams events as they occur, eliminating batch dependencies.

Enables instant synchronization of orders, inventory, and payments.
iii) Asynchronous Processing and Scalability:

Decouples ERP processes from third-party applications.

Supports high-volume transactions with dynamically scalable event consumers.
iv) Intelligent Event Handling:

Implements filtering, transformation, and routing of events based on predefined rules.

Uses AI-driven anomaly detection to identify and mitigate data discrepancies in real time.

According to one embodiment of the invention, use case implementations are implemented in the following domains:
i) e-commerce & Retail: Real-time order updates and inventory synchronization between ERP and online marketplaces;
ii) supply chain & logistics: seamless warehouse integration with dynamic order routing and shipment tracking.
iii) financial services: real-time payment validation and fraud detection through integration with payment gateways.

According to one embodiment of the invention, advantages of the invention are:
i) eliminates data latency by enabling real-time synchronization,
ii) enhances scalability and fault tolerance in ERP integrations,
iii) reduces operational overhead by minimizing manual intervention,
iv) improves customer experience through accurate and timely data exchange.

The Event-Driven ERP Integration Framework revolutionizes enterprise system integrations by shifting from batch-based processing to a real-time event-driven model. Leveraging message-driven architectures and AI-enhanced anomaly detection, the framework ensures agile, responsive, and intelligent ERP integrations, empowering enterprises to excel in dynamic business environments.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

What is claimed is:

1. A system for real-time integration between ERP systems and third-party applications, the system comprising:
a) an event bus utilizing message brokers such as Apache Kafka, AMQP, or SAP Event Mesh;
b) a real-time data synchronization module that streams events as they occur;
c) an asynchronous processing architecture that decouples ERP processes from third-party applications;
d) an intelligent event handling module with filtering, transformation, routing, and AI-driven anomaly detection.

2. The system as claimed in claim 1, wherein the event bus ensures low-latency, high-throughput communication between ERP systems and external applications.

3. The system as claimed in claim 1, wherein the real-time data synchronization module eliminates batch dependencies, enabling instant synchronization of orders, inventory, and payments.

4. The system as claimed in claim 1, wherein the asynchronous processing architecture supports high-volume transaction processing with dynamically scalable event consumers.

5. The system as claimed in claim 1, wherein the intelligent event handling module applies predefined rules for event filtering, transformation, and routing.

6. The system as claimed in claim 1, wherein the intelligent event handling module employs AI-driven anomaly detection to identify and resolve data discrepancies in real time.
